(19) United States
(12) Patent Application Publication
(10) Pub. No.: US 2002/0116655 A1
(43) Pub. Date: Aug. 22, 2002

(54) System, method, and computer program product for dynamic bandwidth quality of service (QoS) provisioning

(75) Inventors: Eugene L. Lew, Olney, MD (US); Ronald K. Dobes, Potomac Falls, VA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GEMINI NETWORKS, INC., FALLS CHURCH, VA

(21) Appl. No.: 10/075,196

(22) Filed: Feb. 15, 2002

Related U.S. Application Data
(60) Provisional application No. 60/268,871, filed on Feb. 16, 2001.
(60) Provisional application No. 60/268,896, filed on Feb. 16, 2001.

(51) Int. Cl. G06F 1/26; G06F 1/28; G06F 1/30

(52) U.S. Cl. 713/323

(57) ABSTRACT

A computer-implemented method, system and computer program product for dynamic quality of service (QoS) provisioning, including receiving from a service provider a generated provisioning event requesting a minimum QoS for a modem based upon a level of service purchased by an end-user from the service provider in all cases; determining whether or not the provisioning event is a time-limited provisioning event; and performing one of the following steps: (a) transmitting a configuration file allowing the modem to operate at least at the minimum QoS, if it is determined that the provisioning event is not a time-limited provisioning event or if it is determined that the provisioning event is a time-limited provisioning event that has not yet expired, and (b) transmitting a configuration file restoring the modem to operate at a previous QoS, if it is determined that the provisioning event is a time-limited provisioning event that has expired.

### CROSS REFERENCE TO RELATED PATENT DOCUMENTS

The present document claims the benefit of the earlier filing date of commonly owned, co-pending U.S. provisional patent application serial No. 60/268,871, entitled “SYSTEM, METHOD, AND COMPUTER PROGRAM PRODUCT FOR DYNAMIC BANDWIDTH QUALITY OF SERVICE (QOS) PROVISIONING,” filed in the U.S. Patent and Trademark Office on Feb. 16, 2001, the entire contents of which is incorporated herein by reference.

The present document contains subject matter related to that disclosed in commonly owned, co-pending: (1) Application Ser. No. 09/784,074 filed Feb. 16, 2001, entitled “SYSTEM, METHOD, AND COMPUTER PROGRAM PRODUCT FOR SUPPORTING MULTIPLE SERVICE PROVIDERS WITH AN INTEGRATED OPERATIONS SUPPORT SYSTEM” (Attorney Docket No. 200876US-8); (2) Application Ser. No. 09/784,068 filed Feb. 16, 2001, entitled “METHOD AND SYSTEM OF EXPANDING A CUSTOMER BASE OF A DATA SERVICES PROVIDER” (Attorney Docket No. 202385US-8); (3) Application Ser. No. 09/784,075 filed Feb. 16, 2001, entitled “SYSTEM, METHOD, AND COMPUTER PROGRAM PRODUCT FOR END-USER SELF-AUTHENTICATION” (Attorney Docket No. 202585US-8); (4) Application Ser. No. 09/784,069 filed Feb. 16, 2001, entitled “SYSTEM, METHOD, AND COMPUTER PROGRAM PRODUCT FOR SUPPORTING MULTIPLE SERVICE PROVIDERS WITH A TROUBLE TICKET CAPABILITY” (Attorney Docket No. 202586US-8); (5) Provisional Application Serial No. 60/268,870 filed Feb. 16, 2001, entitled “SYSTEM, METHOD, AND COMPUTER PROGRAM PRODUCT FOR DYNAMIC BANDWIDTH PROVISIONING” (Attorney Docket No. 202663US-8 PROV); (6) Provisional Application Serial No. 60/268,896 filed Feb. 16, 2001, entitled “SYSTEM, METHOD, AND COMPUTER PROGRAM PRODUCT FOR END-USER SERVICE PROVIDER SELECTION” (Attorney Docket No. 202664US-8 PROV); (7) Provisional Application Serial No. 60/268,865 filed Feb. 16, 2001, entitled “SYSTEM, METHOD, AND COMPUTER PROGRAM PRODUCT FOR AN IRREVOCABLE RIGHT TO USE (IRU) MODEM REGISTRATION PROCESS” (Attorney Docket No. 203050US-8 PROV); (8) Application Ser. No. ______, filed ______, entitled “SYSTEM, METHOD, AND COMPUTER PROGRAM PRODUCT FOR END-USER SERVICE PROVIDER SELECTION” (Attorney Docket No. 214237US-8); (9) Application Ser. No. ______, filed ______, entitled “SYSTEM, METHOD, AND COMPUTER PROGRAM PRODUCT FOR AN IRREVOCABLE RIGHT TO USE (IRU) MODEM REGISTRATION PROCESS” (Attorney Docket No. 214242US-8); and (10) Application Ser. No. ______, filed ______, entitled “SYSTEM, METHOD, AND COMPUTER PROGRAM PRODUCT FOR DYNAMIC BANDWIDTH PROVISIONING” (Attorney Docket No. 214442US-8), the entire contents of each of which being incorporated herein by reference.

### BACKGROUND OF THE INVENTION

1. Field of the Invention

The present invention relates to a method, system and computer program product for supporting dynamic quality of service (QoS) provisioning.

2. Discussion of the Background

FIG. 1 is a block diagram of a conventional hybrid fiber optic/coaxial (HFC) network for providing cable television service and access to the Internet over the same cable television provider network. As shown in FIG. 1, the fiber optic network, including both video content and data, is tapped via a tap 102 of a coaxial cable run from a fiber node 101. From the tap 102, a coaxial cable (i.e., a drop) is run to a splitter 103 where the signal is split into its data and cable television content components. The cable television content is run via a coaxial cable to a television set 104. The data portion of the signal is sent via a coaxial cable to a cable modem 105 connected to, for example, a personal computer 106.

In order to ensure interoperability and availability of parts, the devices used in this system comply with industry standards such as the Data Over Cable Service Interface Specification (DOCSIS). In an exemplary DOCSIS-compliant system, a network having 860 MHz of bandwidth will allocate the band of 5-42 MHz for upstream communications, and some portion within the band of 88-860 MHz for downstream communications.

The cable modem termination system (CMTS) 107 provides an interface between the cable network and the Internet. The CMTS 107 provides the data signal to the cable headend 108 which in turn provides connectivity to a backbone 109 provider. The backbone 109 provides the connectivity to the communications network 100, for example, the Internet. The backbone 109 is a network configured to provide access to the Internet. Access to the backbone 109 is provided by, for example, organizations such as UUNET.

The DOCSIS standard applies to all equipment between the cable modem 105 and the CMTS 107. Accordingly, DOCSIS defines a protocol through which existing cable networks may also be used to provide high-speed bidirectional Internet access.

FIG. 2 is a block diagram showing a conventional dial-up network configuration for providing access to the Internet via an existing telephone network. As shown in FIG. 2, an end-user may connect to the network via a personal computer 201 having, for example, a digital subscriber line (DSL) modem 200. The DSL modem 200 interfaces with the telephone network through a digital subscriber line access multiplexer (DSLAM) 202. Similar to the CMTS 107 shown in FIG. 1, the DSLAM 202 is connected to a backbone 109 through a headend 203. The backbone 109, which may be the same backbone 109 shown in FIG. 1, provides connectivity to the Internet 100.

DSL technology allows digital data to coexist with analog voice data over plain old telephone service (POTS) copper wire networks. As DOCSIS enables the use of existing cable networks for Internet access, technologies such as DSL enable the use of existing telephone networks for Internet access.

As the Internet has become a ubiquitous facet of our society, it is understandable that technologies such as DSL and DOCSIS have well-positioned the telephone companies and the cable television (CATV) companies to benefit. The phone companies and the CATV companies had preexisting networks in place providing connectivity to a large percentage of commercial facilities and residences which desire Internet access. As the technologies evolved permitting multiple uses for the preexisting networks, the telephone companies and cable television providers were able to provide additional services to their existing customer base.

New businesses have also developed in response to the demand for Internet access. For example, Roadrunner's business model is to provide high-speed broadband Internet access services to end-users. They do this by entering into agreements with existing CATV companies so as to gain access to the preexisting CATV HFC network. By owning their own headend, they can provide Internet access to end-users by providing connectivity, through their headend, from the CMTS 107 to the backbone 109.

Other Internet service providers (ISPs) make use of the preexisting telephone system network to gain access to end-users. Similar to the Roadrunner model, these ISPs own their own headend, and provide Internet access to end-users by providing connectivity, through their headend, from the DSLAM 202 to the backbone 109. The existing network owners (i.e., the CATV companies and the telephone companies) have developed systems for provisioning new customers, monitoring network status, and for generating billing for network usage. However, these systems have been evolutionary and have not been developed as a single system, but rather, a collection of separate systems, each having their own interfaces and databases. This has led to significant challenges in maintaining data integrity across the systems, and has also impacted user productivity. Not only do the network owners have to deal with these complexities and inefficiencies, but also, the ISPs connecting to these networks must develop interfaces, oftentimes manual interfaces, between the ISP's internal systems and the network owner's systems. This problem is even worse for an ISP such as Roadrunner which has agreements with many CATV companies, each of which has its own heterogeneous system. It becomes increasingly difficult for an ISP to manage its own systems each time an agreement with a new CATV company or a new telephone company having different systems is reached.

As a general statement, ISPs provide the service of connecting end-users to the Internet by entering into agreements with the owners of the existing networks (i.e., the telephone network and CATV networks), and with the providers of the backbone 109 networks (e.g., UUNET). ISPs typically provide a number of services for their customers, for example, e-mail, news, software downloads, etc. Moreover, ISPs provide a single point of contact for an end-user, alleviating the need for each end-user to interact with the network owner and/or the backbone 109 provider regarding their Internet connectivity.

### SUMMARY OF THE INVENTION

The inventors of the present invention have recognized that currently no methods, systems, or computer program products are available for dynamic quality of service (QoS) provisioning in an open access network for providing broadband data transport services. The broadband data transport services provided in the context of the present invention may include, but are not limited to any combination of analog video, digital video, data services, Internet access, packetized voice, voice-over-Internet Protocol, interactive video, interactive television, near video-on-demand, video-on-demand, data services, and telephony services. Accordingly, one object of the present invention is to provide a solution to this problem, as well as other problems and deficiencies associated with dynamic quality of service (QoS) provisioning in an open access network for providing broadband data transport services.

The above described and other objects are addressed by the present invention which provides a novel computer-implemented method, system and computer program product for dynamic quality of service (QoS) provisioning, including receiving from a service provider a generated provisioning event requesting a minimum QoS for a modem based upon a level of service purchased by an end-user from the service provider in all cases; determining whether or not the provisioning event is a time-limited provisioning event; and performing one of the following steps: (a) transmitting a configuration file allowing the modem to operate at least at the minimum QoS, if it is determined that the provisioning event is not a time-limited provisioning event or if it is determined that the provisioning event is a time-limited provisioning event that has not yet expired, and (b) transmitting a configuration file restoring the modem to operate at a previous QoS, if it is determined that the provisioning event is a time-limited provisioning event that has expired.

Consistent with the title of this section, the above summary is not intended to be an exhaustive discussion of all the features or embodiments of the present invention. A more complete, although not necessarily exhaustive, description of the features and embodiments of the invention is found in the section entitled “DETAILED DESCRIPTION OF THE PREFERRED EMBODIMENTS.”

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of a typical system configuration of a hybrid fiber optic/coaxial (HFC) network for providing cable television service and access to the Internet through the cable television provider network;

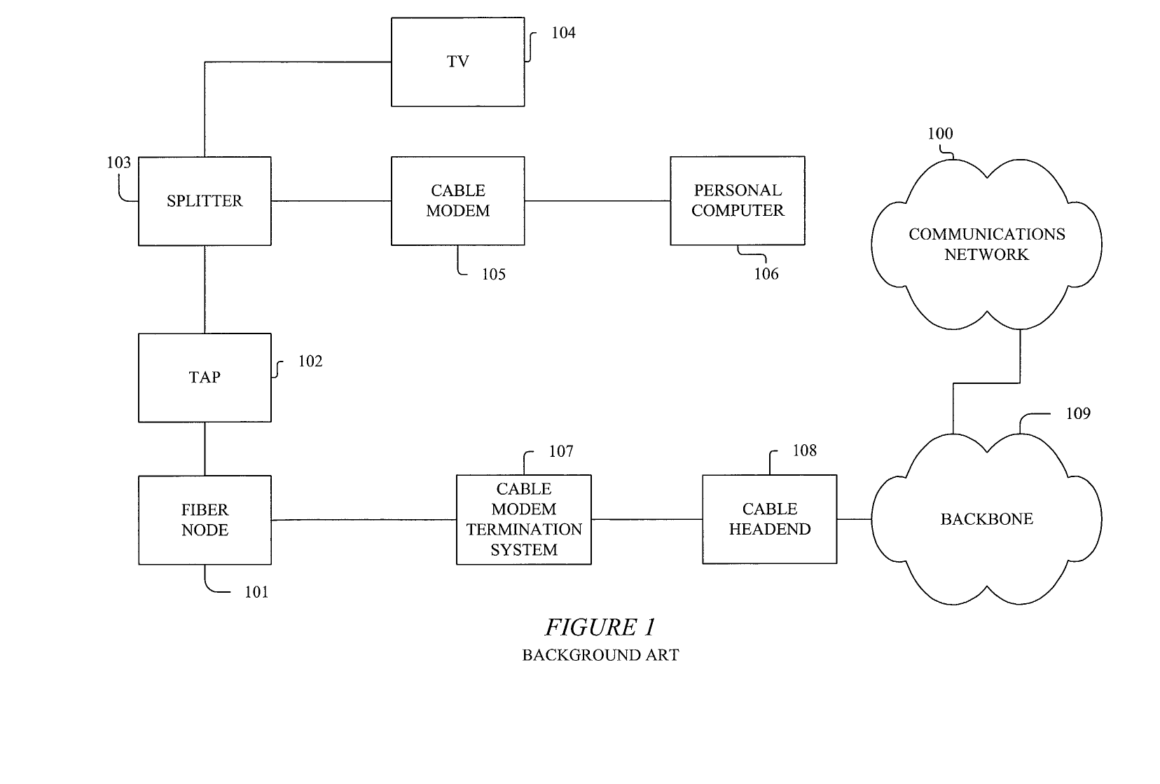

FIG. 2 is a block diagram of a typical dial-up network providing access to the Internet over phone lines;

FIG. 3 is a block diagram of a high-speed network system for providing broadband transport data services (e.g., connecting to an ISP headend to gain access to the Internet) connected to a conventional HFC network providing both cable television and access to a communications network according to one embodiment of the present invention;

FIG. 4 is a block diagram showing the connectivity of multiple hybrid fiber optic/coaxial networks through a single data center of a high-speed network according to one embodiment of the present invention;

FIG. 5 is a block diagram showing the connectivity of remote end-users to geographically based service providers (e.g., an Internet service provider (ISP)) through a high-speed network in one embodiment of the present invention;

FIG. 6 is block diagram showing the connectivity between a common data center of a high-speed network as shown in FIG. 4 and a service provider's (e.g., an ISP) system according to one embodiment of the present invention;

FIG. 7 is a block diagram of a system configuration of an operations support system of a high-speed network to support multiple service providers according to one embodiment of the present invention;

FIG. 8 is a block diagram showing the software architecture of a system for an integrated operations support system of a high-speed network to support multiple service providers according to one embodiment of the present invention;

FIG. 9 shows an exemplary database structure for a database of an operations support system of a high-speed network supporting multiple service providers (e.g., ISPs) according to one embodiment of the present invention;

FIG. 10 is a flow diagram showing an exemplary process for dynamic quality of service (QoS) provisioning according to one embodiment of the present invention; and

FIG. 11 is an exemplary computer system programmed to perform one or more of the special purpose functions of the present invention.

### DETAILED DESCRIPTION OF THE PREFERRED EMBODIMENTS

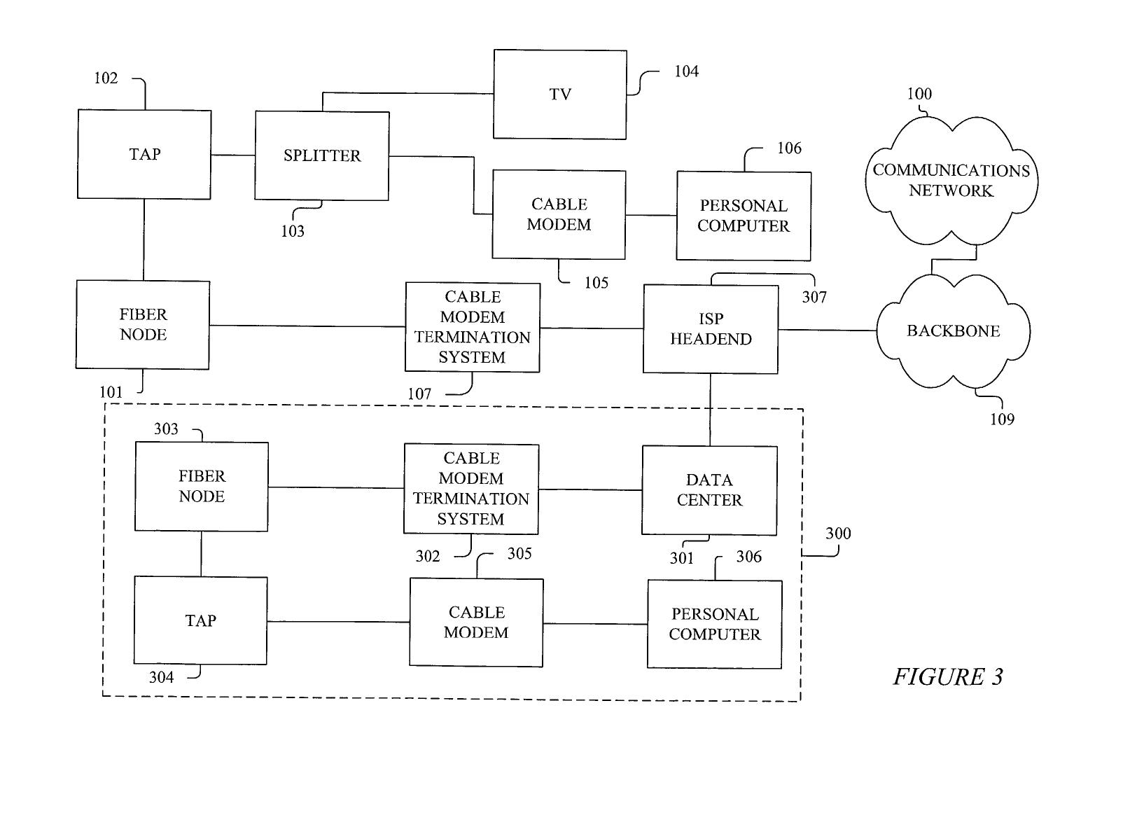

Referring now to the drawings, wherein like reference numerals designate identical or corresponding parts throughout the several views, and more particularly to FIG. 3 thereof, which is a block diagram of a system providing broadband data services, including access to a communications network (e.g., the Internet) according to one embodiment of the present invention. Other broadband data services provided in the context of the present invention may include, but are not limited to any combination of analog video, digital video, data services, packetized voice, voice-over-Internet Protocol, interactive video, interactive television, near video-on-demand, video-on-demand, data services, and telephony services. The system includes a high-speed network 300 for providing broadband data transport services. In one embodiment of the present invention, the high-speed network 300 provides end-users with connectivity to an Internet service provider (ISP) headend 307 to gain access to a communications network 100, for example, the Internet. This connectivity may be provided by using the Data Over Cable Service Interface Specification (DOCSIS) protocol for communications between the end-user cable modem 305 and the cable modem termination system (CMTS) 302 of the high-speed network 300. In further embodiments, protocols other than DOCSIS may be used (e.g., Euro-DOCSIS, fast Ethernet, gigabit Ethernet or other proprietary protocols). In another embodiment, the high-speed network 300 provides end-users with connectivity to an Internet backbone network directly (i.e., via the data center 301) on behalf of the ISP. In further embodiments, the high-speed network 300 for providing broadband data transport services provides voice over Internet Protocol (IP) services or video on demand services. The embodiments described herein will be in the context of providing high-speed access to the Internet by providing end-users with connectivity to ISP headends 307. However, as discussed above, the invention is not limited to this particular embodiment nor is it limited to providing access to any particular network.

The high-speed network 300 is a hybrid fiber optic/coaxial (HFC) network similar to existing cable television (CATV) plants. The high-speed network 300 provides connectivity from end-users, for example, through a personal computer 306 having a cable modem 305, through a coaxial cable to a tap 304 of the fiber optic network. The tap 304 connects the end-user to the coaxial cable portion of the HFC network that connects to the fiber optic network at a node 303. The cable modem 305 communicates with the cable modem termination system (CMTS) 302, which in turn provides connectivity for all end-users of the high-speed network 300 to a common data center 301.

The data center 301 provides connectivity from the high-speed network 300 to an Internet service provider's (ISP) headend 307. The ISP headend 307 is the same headend as described in the BACKGROUND OF THE INVENTION section. For example, the ISP headend 307 may be a cable headend 108 of an ISP providing Internet access over an existing cable network, or it may be a headend 203 of an ISP providing Internet access through dialup connections. In one embodiment of the present invention, the high-speed network 300 provides connectivity to a plurality of ISP headends 307. For example, the end-users from CATV operator ISPs and dial-up ISPs coexist on the same high-speed network 300. The data center 301 is responsible for managing the connectivity between the various ISPs and their particular end-user customers. The ISP headend 307 provides the connectivity to the backbone 109, as described above, which in turn provides the connectivity to the communications network 100, for example, the Internet. Various approaches for connecting to the Internet, including DSL and cable modem connections, are described in White, R., “How Computers Work,” Que, September 1999, and Gralla, P. “How the Internet Works,” Que, August 1999, the entire contents of both of which are incorporated herein by reference.

FIG. 3 illustrates two different networks for gaining access to the Internet 100 through a common ISP headend 307. As discussed above, one path is through the high-speed network 300 for providing broadband data transport services. The other is a preexisting CATV network that provides both cable television content and Internet access. The cable television signal is separated from the data signal at the splitter 103, the cable television signal is provided to a television 104, while the data signal is provided to a cable modem 105 connected to a personal computer 106. The splitter 103 is connected via a coaxial cable to the tap 102. The tap 102 connects the end-user to the coaxial cable portion of the HFC network that in turn connects to the to the fiber optic network at the fiber node 101. The cable modem termination system (CMTS) 107 communicates with the cable modem 105 and provides connectivity to the common ISP headend 307.

The inventors of the present invention have recognized that by providing a high-speed network 300 that is dedicated to particular broadband data transport services, as compared to sharing a preexisting network built for cable television or telephone use, significant improvements in performance may be achieved. For example, some embodiments of the present invention are directed to a high-speed network 300 that is dedicated to providing data services only, for example, Internet access. In these embodiments, the bandwidth of the network can be fully dedicated to that service thereby improving the performance. Other embodiments of the present invention, as described above, are directed to a high-speed network 300 that has not been dedicated to providing a particular service, but rather, provides multiple services. A significant portion of the bandwidth of preexisting CATV networks is dedicated to the downstream transmission of the cable television video. For example, a seventy-channel analog video system requires 420 MHz of bandwidth (6 MHz per channel). Accordingly, standards have been developed to work around that limitation. For example, the Data Over Cable Service Interface Specification (DOCSIS) standard provides that, for an 860 MHz bandwidth channel, the band from 88 MHz to 860 MHz would be reserved for downstream communications. Consequently, devices built for use in a data over cable system must limit their upstream bandwidth to the first 42 MHz. Such allocation limitations do not exist where the high-speed network 300 is dedicated to providing a particular service.

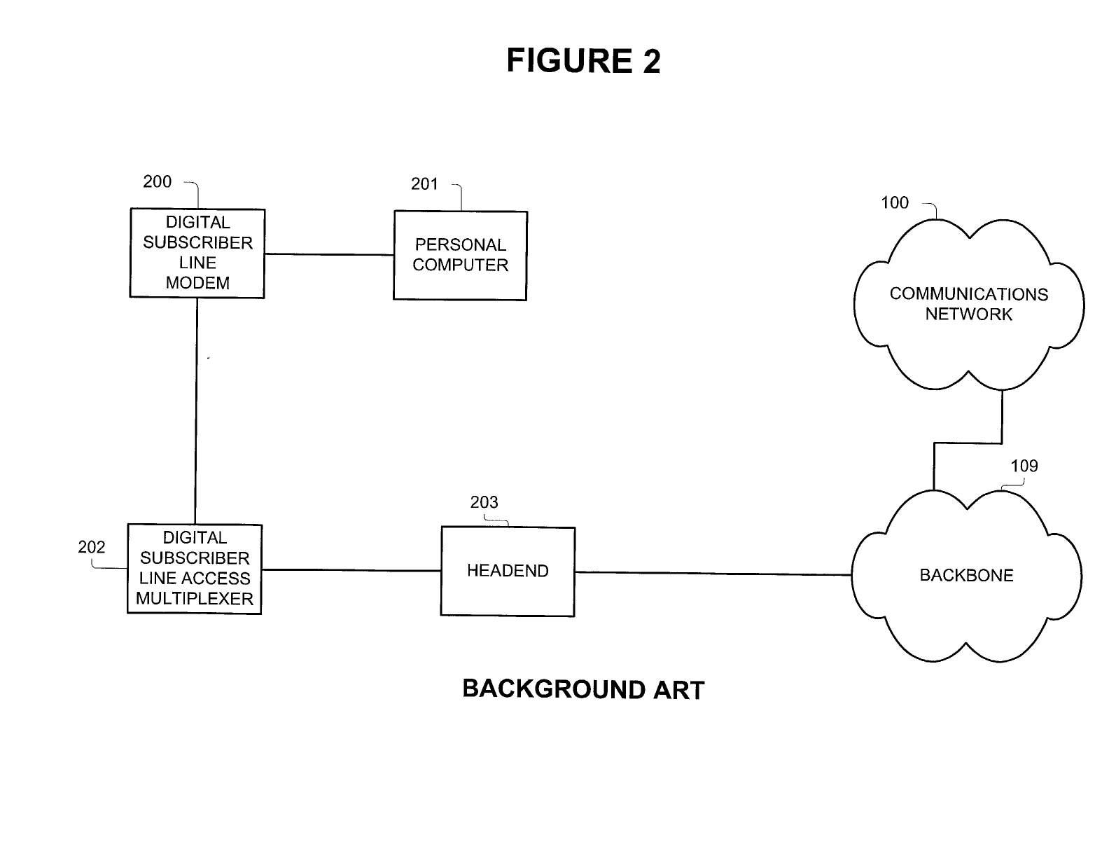

FIG. 3 provides an example showing an ISP headend 307 for a cable provider that also provides Internet access over their cable network. However, this is an exemplary illustration only. The ISP headend 307 could also be a headend 203 for an ISP providing Internet access over telephone lines, as shown in FIG. 2. Alternatively, the ISP headend 307 could be a headend for an Internet service provider such as Roadrunner that provides Internet access through affiliations with various owners of preexisting networks. Moreover, multiple ISP headends 307, of varying types, may be connected to the high-speed network 300 for providing broadband data services.

FIG. 3 illustrates that, in one embodiment of the present invention, an ISP may have connectivity to some customers (i.e., end-users) connected to the ISP headend 307 through its own network, for example, the personal computer 106 connected to the ISP headend 307 through the CMTS 107. In addition, that same ISP may have customers connected to a different, high-speed network 300 for providing broadband data transport services, for example, the personal computer 306 connected to the data center 301 through the CMTS 302. Accordingly, FIG. 3 illustrates that, in one embodiment of the present invention, an ISP may provide services to end-users connected to different networks. In this embodiment, the ISP maintains the relationship with the end-users. If the ISP owns their own network (e.g., a cable television operator) they are responsible for that physical plant as well. If, on the other hand, the ISP does not operate a network (e.g., the Roadrunner example discussed above, where the ISP enters into agreements with the network operators), the ISP must coordinate with the operators of the networks concerning network status, outages, etc. The operator of the high-speed network 300 is responsible for the operation of that plant, and network status information is made available to those ISPs having customers connected to the high-speed network 300.

As discussed above, the present inventors have recognized that Internet connectivity through a high-speed network 300 dedicated to broadband data transport services provides superior performance over conventional approaches. Accordingly, using the exemplary system configuration shown in FIG. 3, an ISP could offer enhanced performance to its customers through providing Internet connectivity via the high-speed network 300 dedicated to providing Internet access, rather than via the preexisting cable television network. Moreover, the present inventors have recognized that by providing a high-speed network 300 based on an open access model, many ISPs can expand their customer base by being able to offer their services in geographic regions not currently served, and moreover, ISPs may offer upgraded performance to new and existing customers by connecting those customers to the high-speed network 300 dedicated to that particular broadband data transport service.

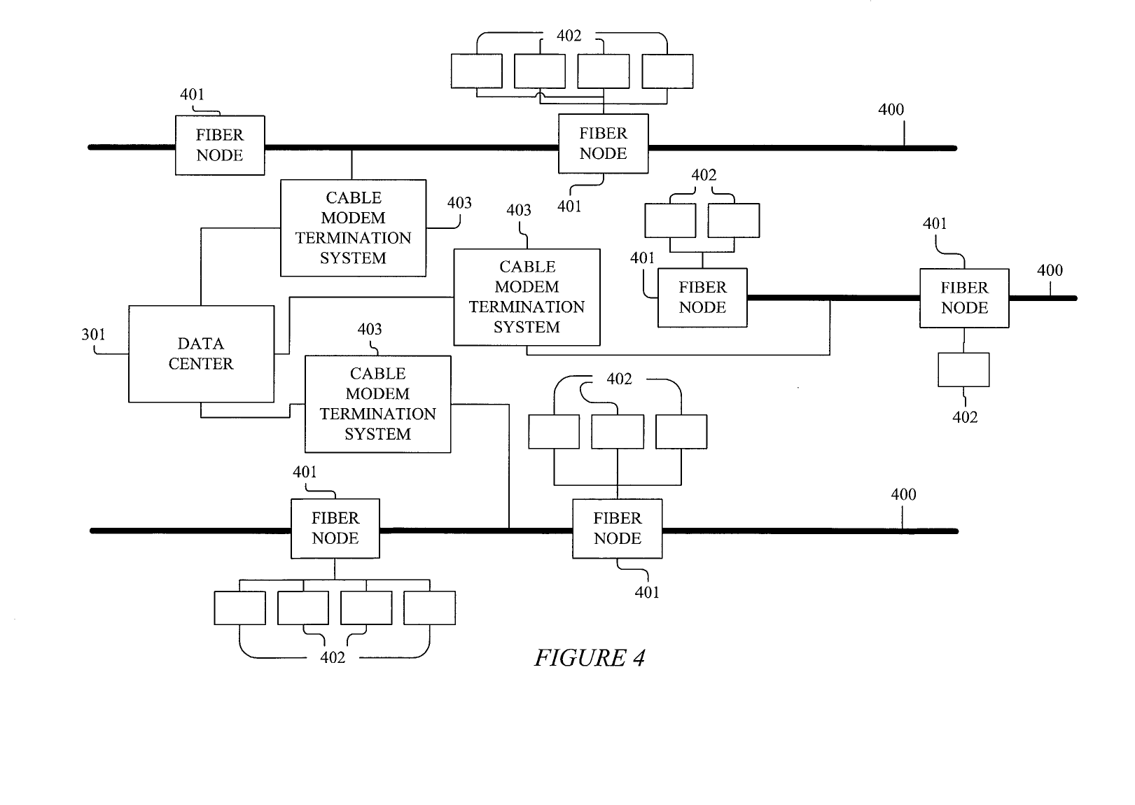

FIG. 4 is a block diagram showing the connectivity of multiple HFC networks through a single data center 301 highlighting another aspect of the present invention. As shown in FIG. 4, the high-speed network simplified as box 300 in FIG. 3 may include several HFC networks 400 that may be geographically dispersed. Each of the HFC networks includes one or more fiber optic nodes 401 that provide connectivity between the fiber optic portion of the network and the coaxial cable portion of the network. For example, each fiber optic node 401 may have connected thereto several end-users 402 via a coaxial cable network. Each end-user 402 is connected to the network, for example, through a cable modem 305. Each of the fiber optic networks 400 is connected to the common data center 301 via a CMTS 403. The common data center 301 provides the connectivity between the geographically dispersed end-users 402 and the various ISP headends 307 having customers on the high-speed network 300.

The availability of a high-speed network 300 that is not geographically restricted, provides an opportunity for existing ISPs (whether or not they operate their own network) to offer their services beyond the geographic limits of their franchise award or agreements with existing network owners. Connectivity between the ISP headend 307 and the common data center 301 provides connectivity between the ISP and the end-users connected to the high-speed network 300 for providing broadband data transport services, regardless of the geographic location of those end-users.

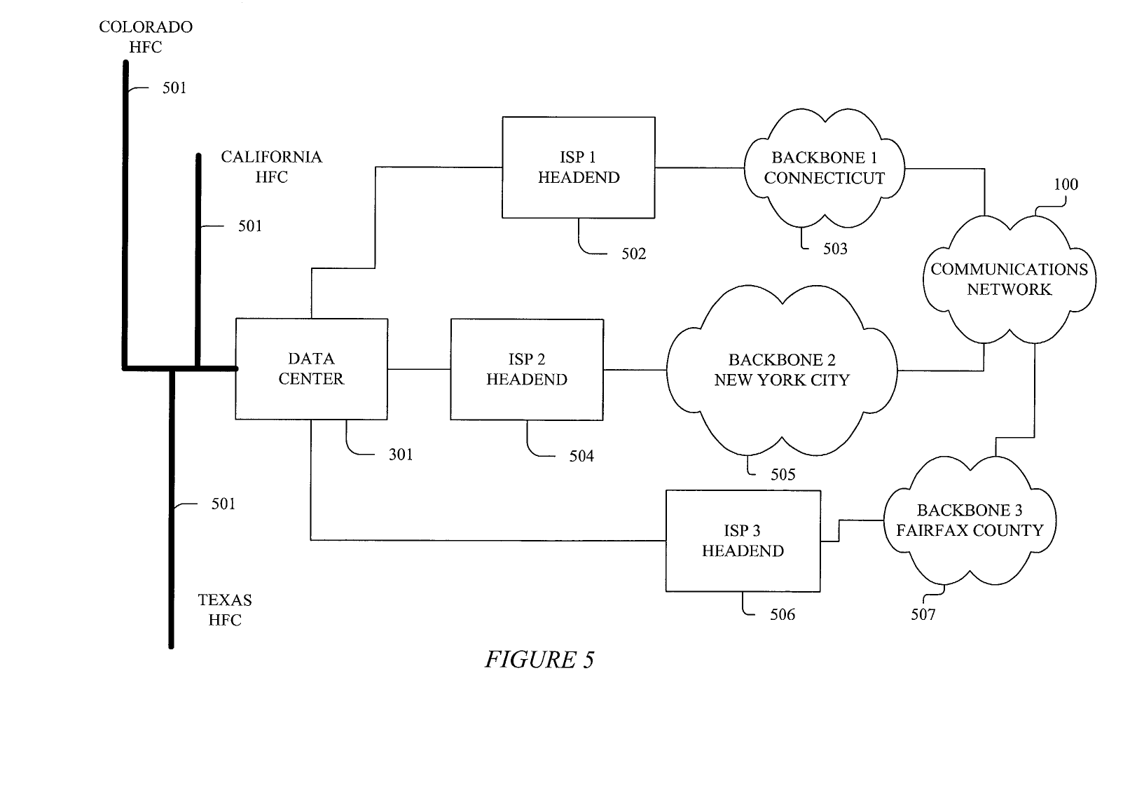

FIG. 5 is a block diagram showing the connectivity of remote customers to geographically based service providers (e.g., ISPs) via the common data center 301 according to one embodiment of the present invention. As shown in FIG. 5, various geographically dispersed HFC networks 501 are connected to a common data center 301. Each of the HFC networks 501 is a high-speed network 300 for providing broadband data transport services. In the exemplary embodiment shown in FIG. 5, the high-speed network 300 is not geographically restricted by, for example, a cable television franchise agreement. As would be understood by those of ordinary skill in the network art, the present invention is equally applicable to other embodiments.

Also shown in FIG. 5 are three exemplary ISP headends 502, 504, 506 representing three ISPs providing connectivity to the Internet 100 via different backbones 503, 505, 507. For example, the ISP 1 headend 502 is connected to the Internet 100 via backbone 1 503 which is based in, for example, Connecticut. In this example, ISP 1 has the cable television franchise for the entire state of Connecticut. Using the system of the present invention, however, ISP 1 would be able to provide ISP services to end-users connected to any one of the HFC networks 501 having connectivity to the common data center 301. Accordingly, ISP 1's Internet access business is no longer restricted to the geographic boundaries of their CATV franchise award.

The common data center 301 of the present invention serves as a clearinghouse for bringing end-users to ISPs. In those embodiments of the present invention where the high-speed network is not geographically restricted, such as the example described above in the context of FIG. 5, the end-users may be from any geographic area served by the high-speed network 300 for providing broadband data transport services. Those customers may or may not be within the geographic boundaries of existing cable television franchise agreements. The ISPs, on the other hand, need not be existing cable television operators. The common data center 301 provides connectivity to end-users for multiple ISPs. The present inventors have recognized that by providing a high-speed network 300 for providing broadband data transport services, ISPs gaining access to the high-speed network 300 will be able to (1) offer their customers enhanced Internet access performance since the high-speed network 300 does not have to reserve bandwidth for video (i.e., cable television content), and (2) have the option of extending the geographic reaches of their business.

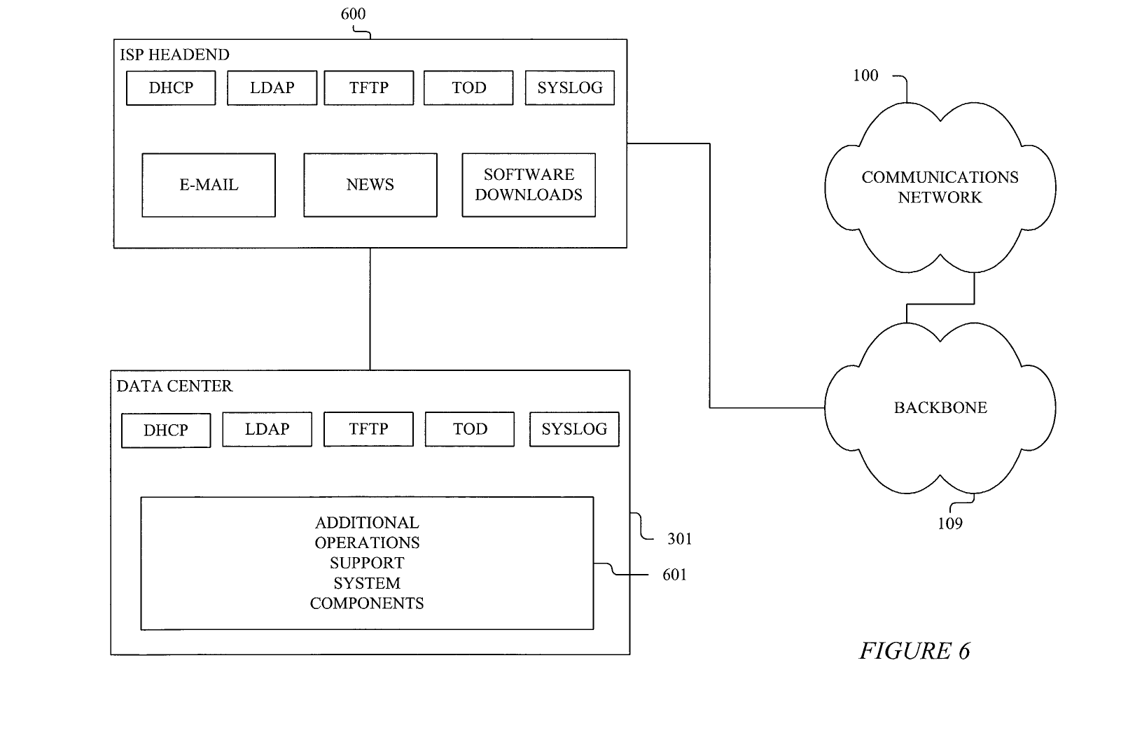

FIG. 6 is a block diagram showing the connectivity between a common data center 301 and an ISP headend 600 according to one embodiment of the present invention. Again, the ISP headend 600 may be for an ISP either having their own network, or an ISP having agreements with network operators (e.g., CATV operators or telephone companies). Both the ISP headend 600 and the common data center 301 provide certain services, such as, for example, Dynamic Host Configuration Protocol (DHCP) services, Lightweight Directory Access Protocol (LDAP) services (typically, but not necessarily integrated with DHCP), Trivial File Transfer Protocol (TFTP) services, Time Of Day (TOD) services, and system logging (SYSLOG) services in order to provide fundamental services to their networks. In one embodiment of the present invention, the ISP headend 600 is further responsible for providing the typical ISP information services provided to the ISP's customers (i.e., the end-users) including, but not limited to e-mail service, news, and software downloads.

The common data center 301 is responsible for managing the high-speed network 300 plant, as well as the interfaces with the various ISPs having customers connected to the high-speed network 300 for providing broadband data transport services. While the common data center 301 is responsible for providing services related to the physical aspects of the high-speed network 300 (e.g., network availability, asset management, etc.), the individual ISPs connected to the common data center 301 are each responsible for interfacing with their customers. The common data center 301 provides a single integrated operations support system (OSS) 601 through which the physical aspects of the high-speed network 300 may be managed, and through which the individual ISPs having customers connected to the high-speed network 300 may manage their relationship with the operator of the high-speed network 300 for providing broadband data transport services. In one embodiment of the present invention, the operations support system 601 includes a billing capability, a provisioning capability, a general ledger and accounts payable system, a trouble ticketing capability, network monitoring capabilities, service availability capabilities, asset management capabilities, and workforce management capabilities. As would be understood by one of ordinary skill in the software art in light of the present specification, further embodiments of the present invention may include various combinations or sub-combinations of the above-described functional capabilities, or even include additional capabilities including, but not limited to, data warehousing and data mining capabilities.

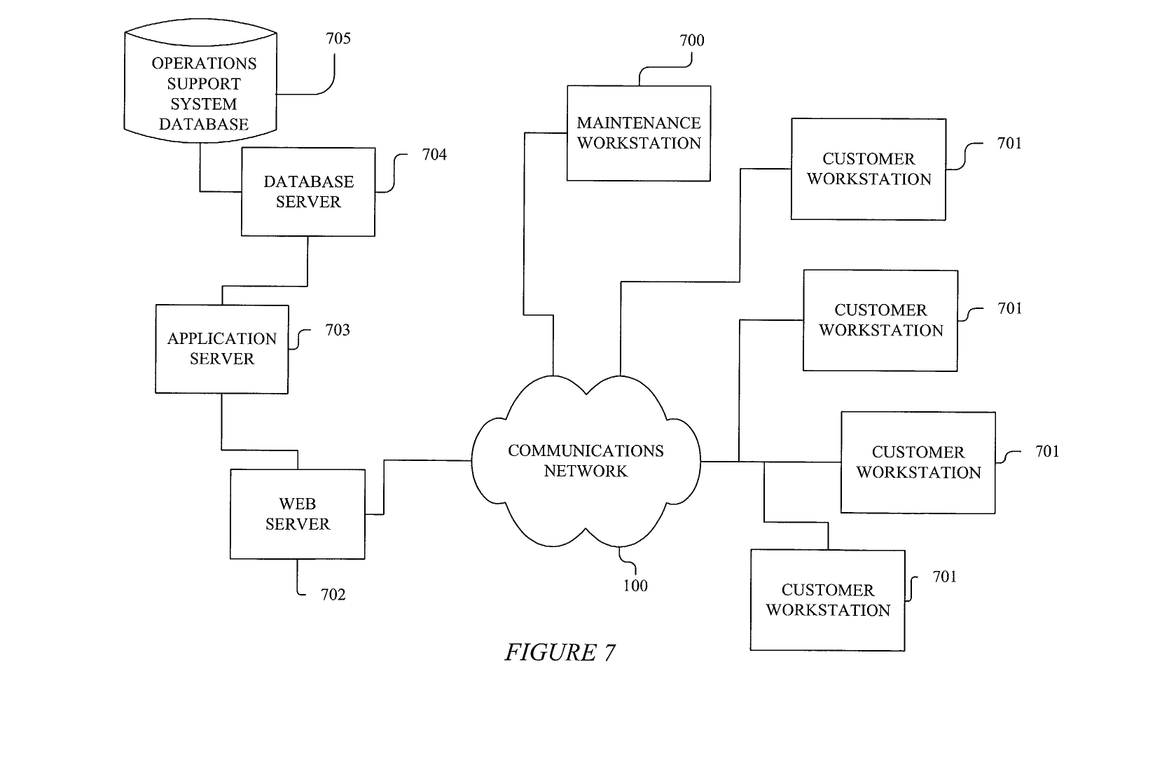

FIG. 7 is a block diagram of a system configuration of an operations support system (OSS) 601 of a common data center 301 as shown in FIG. 6 according to one embodiment of the present invention. As shown in FIG. 7, the system includes a maintenance workstation 700, one or more customer workstations 701 (to provide connectivity for each of the customer ISPs), a communications network 100 (e.g., the Internet), a web server 702, an applications server 703, a database server 704, and an operations support system database 705.

The operations support system database 705 is a digital repository that may be implemented, for example, through a commercially available relational database management system (RDBMS) based on the structured query language (SQL) such as ORACLE, DB2, SYBASE, INFORMIX, or MICROSOFT SQL SERVER, through an object-oriented database management system (ODBMS), or through custom database management software. In one embodiment of the present invention, the operations support system database 705 includes information related to both the physical and usage aspects of the high-speed network 300 for providing broadband data transport services.

For example, the operations support system database 705 includes information related to the plant of the high-speed network 300, including, but not limited to, the geographic availability of the network 300 (i.e., where the high-speed network 300 has been built-out), asset management information, workforce management information including work order status information, trouble ticket information, and network event information. The operations support system database 705 also includes information needed by ISPs having customers on the high-speed network 300. In this regard, as an ISP puts one of their customers onto the high-speed network 300, that ISP becomes a customer of the operator of the high-speed network 300. The operations system support database 705, therefore, includes information such as provisioning information, billing information, general ledger information, and accounts payable information that supports the relationship between the operator of the high-speed network 300 and the ISPs having customers connected to the high-speed network 300.

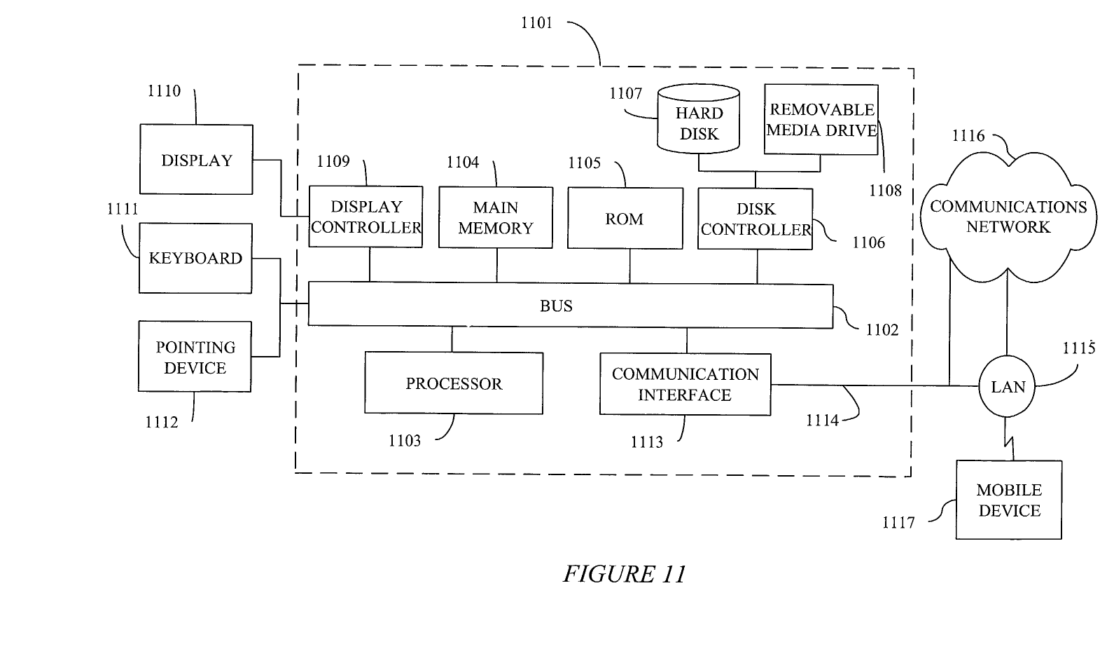

Processes running on the database server 704 maintain the information in the operations support system database 705. The database server 704 is implemented using the computer system 1501 of FIG. 11, for example, but also may be any other suitable personal computer (PC), workstation, server, or device for maintaining the information in the operations support system database 705. The operations support system database 705 may reside on a storage device of the database server 704, or reside on another device connected to the database server 704, for example, by way of a local area network, or other communications link such as a virtual private network, wireless link, or Internet-enabled link.

The applications server 703 may be implemented using the computer system 1501 of FIG. 11, for example, or any other suitable PC, workstation, server, or other device for hosting applications that are used to maintain the various types of information stored in the operations support system database 705. Applications running on the applications server 703 interact with the information held in the operations support system database 705 through the database server 704.

The web server 702 may be implemented using the computer system 1501 of FIG. 11, for example, or any other suitable PC, workstation, server, or other device for hosting an interface through which users may interact with applications running on the applications server 703. In one embodiment of the present invention, the user interface provided by the web server 702 is a world wide web interface accessible through the communications network 100 (e.g., the Internet) via commercially available web browser tools including, but not limited to, INTERNET EXPLORER, available from Microsoft Corporation and NETSCAPE NAVIGATOR, available from Netscape Communications Corporation. The commercially available web browser tool running on the maintenance workstation 700 or the customer workstation 701 provides accessibility to the applications running on the applications server 703 through the web interface provided by the web server 702.

The maintenance workstation 700 may be implemented using the computer system 1501 of FIG. 11, for example, or any other suitable PC, workstation, personal data assistant (PDA), server, or other device for accessing the data in the operations support system database 705 via applications running on the application server 703 through the web based interface provided by the web server 702. In one embodiment, internal personnel may gain access to information in the operations support system database 705 and the applications running on the application server 703 directly (i.e., without going through a common web portal). This direct-access capability is restricted to authorized personnel only. As discussed above, the maintenance workstation 700 may gain access to the web-based interface through a commercially available browser. In one embodiment of the present invention, the maintenance workstation 700 is used to access that information in the operations support system database 705 related to the management of the physical aspects of the high-speed network 300 itself. For example, the maintenance workstation 700 is used to access information relating to network status, trouble ticket status, or work order status. The maintenance workstation 700 is also used for maintaining the operations support system database 705 and the applications running on the application server 703.

The customer workstation 701 may be implemented using the computer system 1501 of FIG. 11, for example, or any other suitable PC, workstation, PDA, server, or other device for accessing information stored in the operations support system database via applications running on the application server 703 through the web based interface provided by the web server 702. As discussed above, the customer workstation 701 may gain access to those applications via a commercially available browser. In one embodiment, the customer workstation 701 is used by ISPs having customers (i.e., end-users) connected to the high-speed network 300. The customer workstation 701 accesses billing information concerning their particular customers, however, ISPs accessing the OSS 601 are restricted from accessing information related to other customers (i.e., other ISPs), nor can they access network management-type information.

In one embodiment of the present invention, strong authentication, authorization and communications integrity are provided for both internal and customer access to the OSS 601. Security may be accomplished through a variety of techniques. For example, security may be imposed at the network level by only accepting traffic from a predetermined set of IP addresses, and by encrypting all data traffic flows using an appropriate technology, such as, for example, Secure Shell (SSH) and Secure HTTP (S-HTTP). User authentication may be performed by using appropriate technologies including, but not limited to, username/password pairs, and one-time password technologies such as SecureID.

The inventors of the present invention have recognized that by providing a single, integrated operations support system (OSS), multiple ISPs can be supported in a secure and authenticated fashion. Internal personnel responsible for the operation of the OSS maintain a single system with which all of their ISP customers interact. By having a single system, only one interface is needed to perform each of the functions supported for the OSS. By not having custom systems or interfaces for each ISP customer, the complexity of the system is decreased, and the reliability of the system is increased, both of which will reduce the cost of maintaining the OSS.

The inventors of the present invention have also recognized that by developing an integrated OSS to have modular architecture and a common database supporting the functions provided by the OSS, components are easily replaced and functionality is easily added or modified. Furthermore, the present inventors have recognized that it is advantageous to have a common web portal for accessing the OSS since the users of the OSS, in particular the ISP customer users, need not develop any software to gain access to the functionality provided. Accordingly, new customers need only have a web browser in order to gain access to the functionality provided by the OSS.

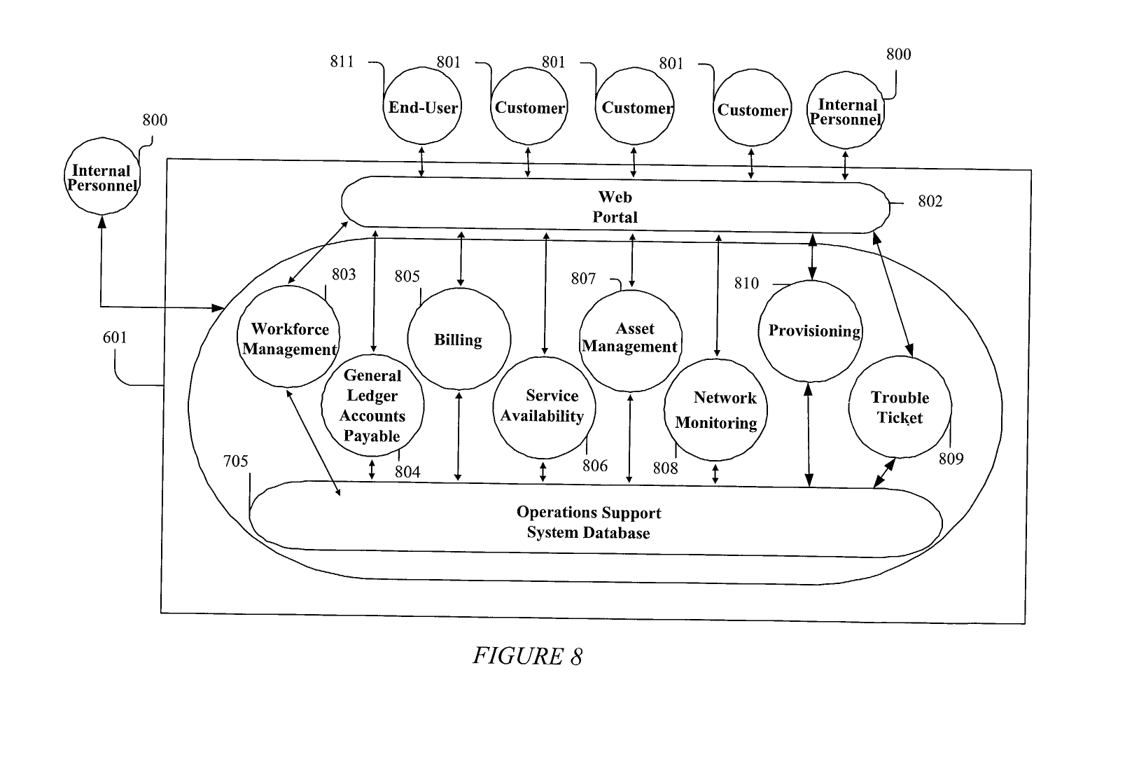

FIG. 8 is a block diagram showing the software architecture of an integrated operations support system (OSS) 601 to support multiple customers (e.g., ISPs) and end-users of the high-speed network 300 according to one embodiment of the present invention. As shown in FIG. 8, the architecture provides a single web portal 802 for all users of the OSS 601. In other words, both internal personnel 800 (i.e., those personnel responsible for the operation of the high-speed network 300), customers 801 (e.g., ISPs having end-users 811 connected to the high-speed network 300) and end-users 811 access the OSS 601 through a single web-based interface, or web portal 802. The web portal 802 provides a single point of access to a variety of software applications through which information in the operations support system database 705 is manipulated. In one embodiment of the present invention, internal personnel 800 may bypass the web portal 802 to gain access to the applications provided by the OSS 601. In this embodiment, as discussed above, this access is restricted to authorized internal personnel 800 only.

In one embodiment of the present invention, the look and feel of the user interface of the web portal 802 is customizable to facilitate integration with established ISP business processes. In one embodiment, the user interface is branded with the logo of the ISP customer. In a further embodiment, sales scripting language (prompts) defined by the ISP may be used through the user interface. In yet another embodiment, the ISP may be given the ability to control account management functions to control which ISP personnel may have access to the OSS 601 via the web portal 802. Any such desired customizations may be provided on a per-customer basis.

In another embodiment of the present invention the web-based user interface is complemented with automated interfaces for certain functional components, for example, billing and provisioning. Having these automated interfaces results in increased system scalability and ISP process efficiencies. These interfaces may be implemented as, for example, an extensible markup language (XML) interface, a file transfer protocol (FTP) interface, an electronic data interchange (EDI) interface, an interface using the rsync Internet protocol, or an electronic mail (e-mail) interface. In another embodiment of the present invention, OSS 601 functionality is accessible through an application programmer's interface (API).

In one embodiment of the present invention, the operations support system database 705 is implemented as a single master ORACLE relational database providing a single common repository accessed by all applications, whether those applications are supporting internal functions for internal personnel 800, or customer functions supporting customers 801. Further embodiments of the present invention use multiple database instances specific to a particular functionality (e.g., billing, provisioning, network monitoring, etc.), each of which is coordinated through a single master database.

In one embodiment of the present invention, customers 801 interact with the web portal 802 via a customer workstation 701, internal personnel 800 interact with the web portal 802 through a maintenance workstation 700 and end-users 811 interact with the web portal 802 through personal computers 106, the web portal 802 is provided by the web server 702, the various applications are hosted by the applications server 703, and the operations support system database 705 is managed by the database server 704.

As shown in FIG. 8, in one embodiment of the present invention, the operations support system 601 includes a workforce management application 803, a general ledger and accounts payable application 804, a billing application 805, a service availability application 806, an asset management application 807, a network monitoring application 808, a trouble ticket application 809, and a provisioning application 810. As discussed above, all of the various software applications are accessible via the common web portal 802 and store and retrieve information from the common operations support system database 705. Of course, the applications included in the OSS 601 may vary with different embodiments of the present invention. The OSS 601 provides an integrated system for managing the high-speed network 300 plant as well as its usage.

As recognized by the present inventors, it is advantageous to provide access to the various applications required to manage the high-speed network 300 itself, as well as its usage, through a common web portal 802 such that customers 801, internal personnel 800 and end-users 811 may access the information stored in the operations support system database 705 by simply having access to a commercially available browser. In other words, no customer software is required by either the operators of the network (i.e., internal personnel 800), the customers 801 (e.g., ISPs) of the network or the end-users 811. Furthermore, the present inventors have recognized that by storing all information in a common operations support system database 705, having a common data model, the sharing of information between the various applications will be facilitated. Moreover, the integrity of the information stored in the operations support system database 705 will be maximized. The present inventors have recognized that it is advantageous, from both a technical and business perspective, to have an integrated OSS 601 based on a common operations support system database 705.

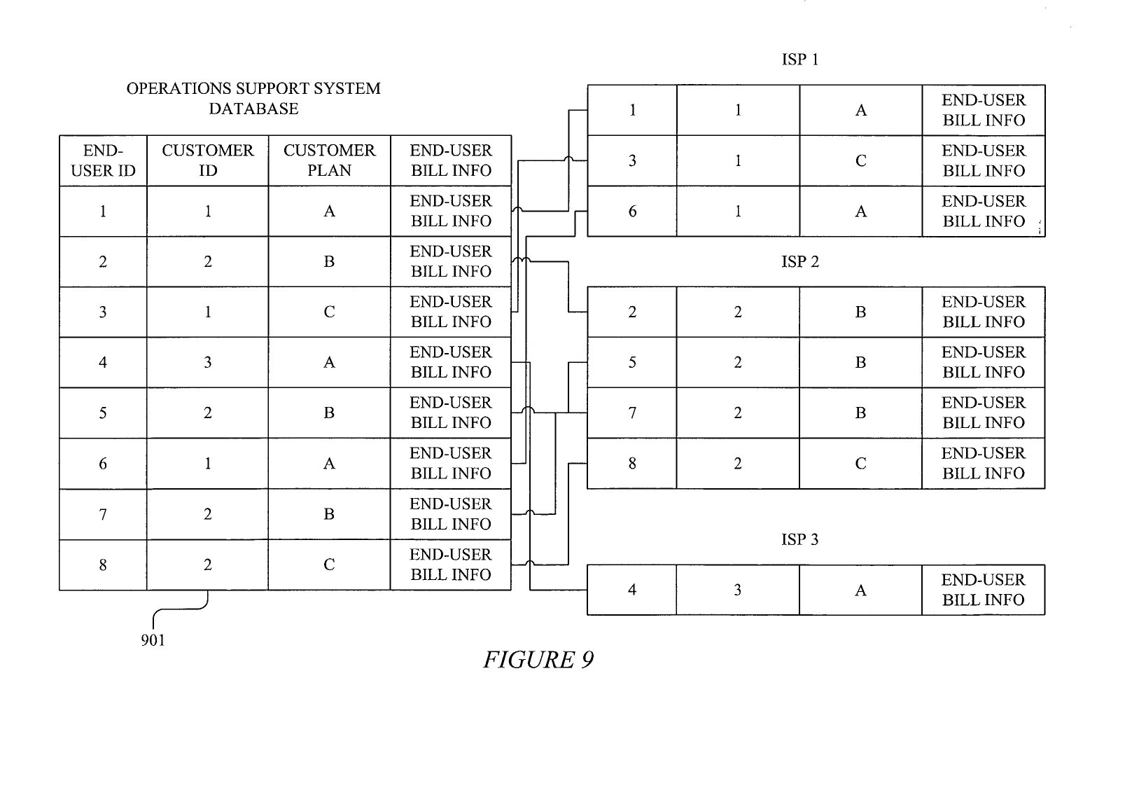

FIG. 9 shows an exemplary database structure for an operations support system database 705 supporting multiple customers 801 (e.g., ISPs) according to one embodiment of the present invention. As shown in FIG. 9, a single query of the operations support system database 705 produces a result 901 that may include several end-users 811 (i.e., individual connections to the high-speed network 300), each end-user 811 being a customer of a particular ISP, each of those ISPs being a customer 801 of the high-speed network 300. Each customer 801 of the high-speed network 300 (e.g., an ISP) may offer a variety of service plans to their customers (i.e., end-users 811). For example, a particular ISP may offer three different rate plans (e.g., customer plan A, customer plan B, customer plan C). Each of those rate plans would cause different billing information to be generated based on the customer plan subscribed to as defined in the billing application 805 for that particular end-user 811.

As customers 801 access information stored in the operations support system database 705, they are restricted from viewing any records other than those corresponding to end-users 811 which are their customers. For example, as shown in FIG. 9, when customer ISP 1 accesses the operations support system database 705 via the web portal 802, ISP 1 will only have access to records relating to end-users 811 having IDs 1, 3, and 6, as those end-users 811 have a customer-provider relationship with ISP 1. Similarly, when customer ISP 2 accesses the operations support system database 705, ISP 2 will only have access to records pertaining to end-users 811 having IDs 2, 5, 7, and 8, and so on. The inventors of the present invention have recognized that from a technical and business perspective, that it is advantageous to store information relating to all of the customers 801 of the high-speed network 300 in a common format in a common operations support system database 705. Accordingly, the operators of the high-speed network 300 need only provide a single user interface to the operations support system 601 that may be accessed by all customers 801. Moreover, the complexity of the operations support system database 705 is minimized, as are the various interfaces between the applications 803-809 and the operations support system database 705. The inventors of the present invention have further recognized that by maintaining information of interest to the operators of the high-speed network 300 and information of interest to the customers 801 in a common operations support system database 705 accessible through a single web portal 802, they have alleviated the need to have separate software applications providing interfaces between a variety of systems.

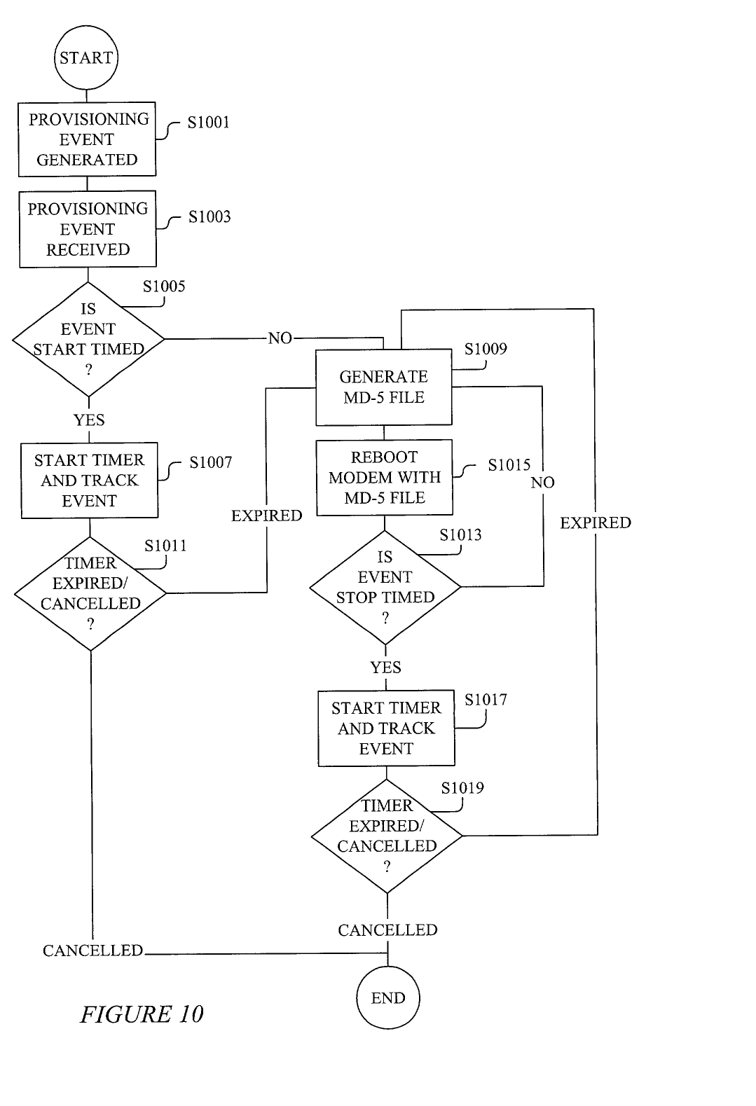

FIG. 10 is a flow diagram showing an exemplary process for dynamic quality of service (QoS) provisioning according to one embodiment of the present invention. Quality of service is a term used herein to describe, for example, committed levels of bandwidth between the cable modem 105 and the CMTS 403, as for example, is enabled for individual service flows within the cable modem 105 using DOCSIS 1.1 and subsequent versions of that technology (e.g., DOCSIS 2.0). However, according to the present invention, QoS may also generally encompass, for example, basic performance parameters, such as (1) network availability, (2) error performance, (3) lost calls or transmissions due to network congestion, (4) connection setup time, (5) speed of fault detection and correction, etc. In this respect, service providers usually guarantee the availability and error performance of their networks. Generally, these parameters are checked while the network is in service (i.e., carrying traffic), for example, using a network management system, such as the Operations Support System (OSS) 601.

In FIG. 10, the OSS 601 is enabled to generate, in real-time, an appropriate MD5 cable modem 105 provisioning file with a requested QoS enabled at step S1009. In other embodiments of the present invention, digital signature algorithms other than MD5 are used for the provisioning file. Using DHCP and TFTP in one embodiment of the present invention, the cable modem 105 is then rebooted at step S1015 to obtain this configuration file, which specifies the minimum level of QoS at which the cable modem 105 will operate, as requested by some provisioning event at steps S1001 and as received by the OSS 601 at step S1003. As would be understood by those of ordinary skill in the software art, other file transfer utilities, such as, for example, a file transfer protocol (FTP) could be used to obtain the configuration file. Such provisioning event at step S1001 may be generated, for example, by a CSR (Customer Service Representative), the end-user 811 of the cable modem 105, some non-human triggering event through hardware, software, a combination thereof, etc.

If it is determined at step S1005 that there are no timed events associated with the requested QoS, the cable modem 105 is immediately rebooted at step S1015 with an appropriate configuration file generated at step S1009. If it is determined at step S1005 that the requested QoS is to be started after a given amount of time, a timer event is started at step S1007, after the expiration of which detected at step S1011 the cable modem 105 is rebooted at step S1015 with an appropriate configuration file generated at step S1009.

At this point, a determination is made at step S1013 as to whether or not the existing QoS level should be stopped and the original QoS level should be applied after a given amount of time. If not, the new QoS level is maintained and the process is complete. If so, a second timer event is started at step S1017, after the expiration of which detected at step S1019 the cable modem 105 is rebooted at step S1015 with an appropriate configuration file generated at step S1009 corresponding to the original QoS level.

Using the OSS 601, any running timer may be cancelled at any time as detected at steps S1011 and/or S1019, in which case the cable modem 105 will continue to operate at its currently provisioned QoS level. The OSS 601 is aware and subsequently tracks all such events associated with such activity at steps S1007 and/or S1017 to enable logging and triggering of associated events to include, for example, billing and other derivative actions so desired of such actions.

FIG. 11 illustrates a computer system 1101 upon which an embodiment of the present invention may be implemented. The present invention may be implemented on a single such computer system, or a collection of multiple such computer systems. The computer system 1101 includes a bus 1102 or other communication mechanism for communicating information, and a processor 1103 coupled with the bus 1102 for processing the information. The computer system 1101 also includes a main memory 1104, such as a random access memory (RAM) or other dynamic storage device (e.g., dynamic RAM (DRAM), static RAM (SRAM), and synchronous DRAM (SDRAM)), coupled to the bus 1102 for storing information and instructions to be executed by processor 1103. In addition, the main memory 1104 may be used for storing temporary variables or other intermediate information during the execution of instructions by the processor 1103. The computer system 1101 further includes a read only memory (ROM) 1105 or other static storage device (e.g., programmable ROM (PROM), erasable PROM (EPROM), and electrically erasable PROM (EEPROM)) coupled to the bus 1102 for storing static information and instructions for the processor 1103.

The computer system 1101 also includes a disk controller 1106 coupled to the bus 1102 to control one or more storage devices for storing information and instructions, such as a magnetic hard disk 1107, and a removable media drive 1108 (e.g., floppy disk drive, read-only compact disc drive, read/write compact disc drive, compact disc jukebox, tape drive, and removable magneto-optical drive). The storage devices may be added to the computer system 1101 using an appropriate device interface (e.g., small computer system interface (SCSI), integrated device electronics (IDE), enhanced-IDE (E-IDE), direct memory access (DMA), or ultra-DMA).

The computer system 1101 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1101 may also include a display controller 1109 coupled to the bus 1102 to control a display 1110, such as a cathode ray tube (CRT), for displaying information to a computer user. The computer system includes input devices, such as a keyboard 1111 and a pointing device 1112, for interacting with a computer user and providing information to the processor 1103. The pointing device 1112, for example, may be a mouse, a trackball, or a pointing stick for communicating direction information and command selections to the processor 1103 and for controlling cursor movement on the display 1110. In addition, a printer may provide printed listings of the data structures/information shown in FIGS. 10 and 11, or any other data stored and/or generated by the computer system 1101.

The computer system 1101 performs a portion or all of the processing steps of the invention in response to the processor 1103 executing one or more sequences of one or more instructions contained in a memory, such as the main memory 1104. Such instructions may be read into the main memory 1104 from another computer readable medium, such as a hard disk 1107 or a removable media drive 1108. One or more processors in a multi-processing arrangement may also be employed to execute the sequences of instructions contained in main memory 1104. In alternative embodiments, hard-wired circuitry may be used in place of or in combination with software instructions. Thus, embodiments are not limited to any specific combination of hardware circuitry and software.

As stated above, the computer system 1101 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1101, for driving a device or devices for implementing the invention, and for enabling the computer system 1101 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1103 for execution. A computer readable medium may take many forms, including but not limited to, non-volatile media, volatile media, and transmission media. Non-volatile media includes, for example, optical, magnetic disks, and magneto-optical disks, such as the hard disk 1107 or the removable media drive 1108. Volatile media includes dynamic memory, such as the main memory 1104. Transmission media includes coaxial cables, copper wire and fiber optics, including the wires that make up the bus 1102. Transmission media also may also take the form of acoustic or light waves, such as those generated during radio wave and infrared data communications.

Various forms of computer readable media may be involved in carrying out one or more sequences of one or more instructions to processor 1103 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1101 may receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1104, from which the processor 1103 retrieves and executes the instructions. The instructions received by the main memory 1104 may optionally be stored on storage device 1107 or 1108 either before or after execution by processor 1103.

The computer system 1101 also includes a communication interface 1113 coupled to the bus 1102. The communication interface 1113 provides a two-way data communication coupling to a network link 1114 that is connected to, for example, a local area network (LAN) 1115, or to another communications network 1116 such as the Internet. For example, the communication interface 1113 may be a network interface card to attach to any packet switched LAN. As another example, the communication interface 1113 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1113 sends and receives electrical, electromagnetic or optical signals that carry digital data streams representing various types of information.

The network link 1114 typically provides data communication through one or more networks to other data devices. For example, the network link 1114 may provide a connection to another computer through a local network 1115 (e.g., a LAN) or through equipment operated by a service provider, which provides communication services through a communications network 1116. In preferred embodiments, the local network 1114 and the communications network 1116 preferably use electrical, electromagnetic, or optical signals that carry digital data streams. The signals through the various networks and the signals on the network link 1114 and through the communication interface 1113, which carry the digital data to and from the computer system 1101, are exemplary forms of carrier waves transporting the information. The computer system 1101 can transmit and receive data, including program code, through the network(s) 1115 and 1116, the network link 1114 and the communication interface 1113. Moreover, the network link 1114 may provide a connection through a LAN 1115 to a mobile device 1117 such as a personal digital assistant (PDA), laptop computer, or cellular telephone. The LAN communications network 1115 and the communications network 1116 both use electrical, electromagnetic or optical signals that carry digital data streams. The signals through the various networks and the signals on the network link 1114 and through the communication interface 1113, which carry the digital data to and from the system 1101, are exemplary forms of carrier waves transporting the information. The computer system 1101 can transmit notifications and receive data, including program code, through the network(s), the network link 1114 and the communication interface 1113.

The present invention enables dynamic adjustment/change of provisioned quality of service (QoS) of a cable modem subscriber based upon a level of service purchased by the subscriber from a service provider in all cases. The present invention provides for “QoS on demand”, whereby a subscriber can request desired bandwidth levels from a service provider, and the service provider in turn can communicate the associated service parameters to the OSS 601. Possible applications are to fulfill the specific needs of a QoS application, such as VOD (Video on Demand), streaming video/audio, large data files to be downloaded, telephony, etc. Current systems do not allow for the dynamic alteration of provisioned QoS without a full re-provisioning of service agreements between a service provider and a consumer. The present invention enables both a service provider and a consumer to purchase/provision “QoS on demand” on an as-needed or required basis. The present invention thus enables the service provider and the consumer to change provisioned QoS of a cable modem “dynamically” on an as needed or requested basis.

Obviously, numerous modifications and variations of the present invention are possible in light of the above teachings. It is therefore to be understood that within the scope of the appended claims, the invention may be practiced otherwise than as specifically described herein.

What is claimed is:

1. A method for dynamic quality of service provisioning, comprising the steps of:
receiving a provisioning event requesting a minimum quality of service for a modem;
generating a modem configuration file for the modem to implement the minimum quality of service based on the provisioning event;
rebooting the modem; and
transmitting the modem configuration file to the modem such that the modem will implement the minimum quality of service.

2. The method of claim 1, further comprising the steps of:
determining after the receiving step whether the provisioning event is a start time provisioning event after the receiving step;
waiting for a start time if the provisioning event is a start time provisioning event; and
performing the generating, rebooting, and transmitting steps when the start time has been reached.

3. The method of claim 1, further comprising the steps of:
determining after the receiving step whether the provisioning event is a stop time provisioning event after the receiving step;
waiting for a stop time if the provisioning event is a stop time provisioning event;
generating another modem configuration file for the modem when the stop time has been reached to implement a previous minimum quality of service based on a quality of service of the modem prior to receiving the provisioning event;
rebooting the modem; and
transmitting the another modem configuration file to the modem such that the modem will implement the previous minimum quality of service.

4. The method of claim 1, wherein the configuration file comprises a digitally signed file.

5. The method of claim 1, wherein the configuration file comprises an MD5 file..

6. The method of claim 1, wherein the rebooting step comprises rebooting the modem using dynamic host configuration protocol commands.

7. The method of claim 1, wherein the transmitting step comprises transmitting the modem configuration file using at least one of a trivial file transfer protocol, a file transfer protocol, and another transfer utility.

8. The method of claim 1, wherein the minimum quality of service comprises at least one of a committed level of bandwidth, a network availability, an error performance, a metric of lost calls or transmissions due to network congestion, a connection setup time, and a speed of fault detection or correction.

9. The method of claim 1, where the receiving step comprises receiving the provisioning event through at least one of a customer service representative, an end-user of the modem, and a non-human triggering event through at least one of a hardware device or software mechanism.

10. A system for dynamic quality of service provisioning, comprising:
a processor; and
a computer readable medium encoded with processor readable instructions that when executed by the processor implement
a provisioning event reception mechanism configured to receive a provisioning event requesting a minimum quality of service for a modem,
a modem configuration file generation mechanism configured to generate a modem configuration file for the modem to implement the minimum quality of service based on the provisioning event,
a reboot mechanism configured to reboot the modem, and
a configuration file transmission mechanism configured to transmit the modem configuration file to the modem such that the modem will implement the minimum quality of service.

11. The system of claim 10, further comprising:
a provisioning event categorization mechanism configured to categorize a received provisioning event as one of a non-time dependent provisioning event, a start time provisioning event, and a stop time provisioning event;
a start time provisioning event processing mechanism configured to wait for a start time if the received provisioning event is a start time provisioning event prior to generating the modem configuration file, rebooting the modem, and transmitting the modem configuration file to the modem; and
a stop time provisioning event processing mechanism configured to
wait for a stop time if the provisioning event is a stop time provisioning event prior to generating another modem configuration file for the modem when the stop time has been reached to implement a previous minimum quality of service based on a quality of service of the modem prior to receiving the provisioning event,
reboot the modem, and
transmit the another modem configuration file to the modem such that the modem will implement the previous minimum quality of service.

12. The system of claim 10, wherein the configuration file comprises a digitally signed file.

13. The system of claim 10, wherein the configuration file comprises an MD5 file.

14. The system of claim 10, wherein the reboot mechanism is further configured to reboot the modem using dynamic host configuration protocol commands.

15. The system of claim 10, wherein the configuration file transmission mechanism is further configured to transmit the modem configuration file using at least one of a trivial file transfer protocol, a file transfer protocol, and another transfer utility.

16. The system of claim 10, wherein the minimum quality of service comprises at least one of a committed level of bandwidth, a network availability, an error performance, a metric of lost calls or transmissions due to network congestion, a connection setup time, and a speed of fault detection or correction.

17. The system of claim 10, wherein the provisioning event reception mechanism is further configure to receive the provisioning event through at least one of a customer service representative, an end-user of the modem, and a non-human triggering event through at least one of a hardware device or software mechanism.

18. A system for dynamic quality of service provisioning, comprising:
means for receiving a provisioning event requesting a minimum quality of service for a modem;
means for generating a modem configuration file for the modem to implement the minimum quality of service based on the provisioning event;
means for rebooting the modem; and
means for transmitting the modem configuration file to the modem such that the modem will implement the minimum quality of service.

19. A computer program product, comprising:
a computer storage medium; and
a computer program code mechanism embedded in the computer storage medium for causing a processor to perform dynamic quality of service provisioning, the computer program code mechanism having,
a first computer code device configured to receive a provisioning event requesting a minimum quality of service for a modem,
a second computer code device configured to generate a modem configuration file for the modem to implement the minimum quality of service based on the provisioning event,
a third computer code device configured to reboot the modem, and
a fourth computer code device configured to transmit the modem configuration file to the modem such that the modem will implement the minimum quality of service.

20. The computer program product of claim 19, wherein the computer program code mechanism further comprises
a fifth computer code device configured to categorize a received provisioning event as one of a non-time dependent provisioning event, a start time provisioning event, and a stop time provisioning event;
a sixth computer code device configured to wait for a start time if the received provisioning event is a start time provisioning event prior to generating the modem configuration file, rebooting the modem, and transmitting the modem configuration file to the modem; and
a seventh computer code device configured to
wait for a stop time if the provisioning event is a stop time provisioning event prior to generating another modem configuration file for the modem when the stop time has been reached to implement a previous minimum quality of service based on a quality of service of the modem prior to receiving the provisioning event,
reboot the modem, and
transmit the another modem configuration file to the modem such that the modem will implement the previous minimum quality of service.

21. The computer program product of claim 19, wherein the configuration file comprises a digitally signed file.

22. The computer program product of claim 19, wherein the configuration file comprises an MD5 file.

23. The computer program product of claim 19, wherein the third computer code device is further configured to reboot the modem using dynamic host configuration protocol commands.

24. The computer program product of claim 19, wherein the fourth computer code device is further configured to transmit the modem configuration file using at least one of a trivial file transfer protocol, a file transfer protocol, and another transfer utility.

25. The computer program product of claim 19, wherein the minimum quality of service comprises at least one of a committed level of bandwidth, a network availability, an error performance, a metric of lost calls or transmissions due to network congestion, a connection setup time, and a speed of fault detection or correction.

26. The computer program product of claim 19, wherein the first computer code device is further configure to receive the provisioning event through at least one of a customer service representative, an end-user of the modem, and a non-human triggering event through at least one of a hardware device or software mechanism.
